(19) United States
(12) Patent Application Publication
(10) Pub. No.: US 2008/0110683 A1
(43) Pub. Date: May 15, 2008

(54) Plug-in hybrid accessory drive system

(76) Inventor: Alexander Serkh, Troy, MI (US)

Correspondence Address: THE GATES CORPORATION, IP LAW DEPT. 10-A3, 1551 WEWATTA STREET, DENVER, CO, 80202, US

(21) Appl. No.: 11/595,417

(22) Filed: Nov. 10, 2006

(51) Int. Cl. B60K 6/00

(52) U.S. Cl. 180/65.2; 903/904

(57) ABSTRACT

A plug-in hybrid accessory belt drive system comprising a vehicle engine accessory belt drive, the accessory belt drive comprising engine accessories, a motor/generator engaged with the accessory belt drive, the motor/generator for driving the accessory drive, a rechargeable electrical energy source connected to the motor/generator for driving the motor/generator on demand, the rechargeable electrical energy course connected to a vehicle electrical load, and the rechargeable electrical energy source connectable to a recharging energy source.

### FIELD OF THE INVENTION

The invention relates to a plug-in hybrid accessory drive system, and more particularly, to a plug-in hybrid accessory drive system comprising a rechargeable electrical power source connected to a motor/generator for operating engine accessories independently of the engine.

### BACKGROUND OF THE INVENTION

It is known that hybrid electric vehicles are more fuel efficient that non-hybrid vehicles. The average hybrid vehicle costs about $3000-$5000 more that the non-hybrid. It is also known that hybrid electric vehicle has different architecture and design of most of its components. As a result high volume production of these vehicles is difficult. The average fuel consumption and CO reduction that can be achieved by hybrid electric vehicles is about 30%.

Engine auxiliaries consume 30% to 50% of energy during highway or city driving. Reduction of engine auxiliary speed can reduce fuel consumption and emissions by approximately 5%. Further, elimination of engine idle cycle can reduce fuel consumption and emissions by 5% -10%.

Representative of the art is U.S. Pat. No. 6,964,631 to Moses et al. which discloses an electric motor connected solidly to the main transmission oil pump shaft on the transmission case. An off-axis chain and gear are connected to the main oil pump shaft via a single freewheeling clutch, so that either source of torque in a hybrid motor can drive the oil pump or the oil pump can be driven by the electric motor or the hybrid motor depending on which motor is traveling at a higher speed.

What is needed is a plug-in hybrid accessory drive system comprising a rechargeable electrical power source connected to a motor/generator for operating engine accessories independently of the engine. The present invention meets this need.

### SUMMARY OF THE INVENTION

The primary aspect of the invention is to provide a plug-in hybrid accessory drive system comprising a rechargeable electrical power source connected to a motor/generator for operating engine accessories independently of the engine.

Other aspects of the invention will be pointed out or made obvious by the following description of the invention and the accompanying drawings.

The invention comprises a plug-in hybrid accessory belt drive system comprising a vehicle engine accessory belt drive, the accessory belt drive comprising engine accessories, a motor/generator engaged with the accessory belt drive, the motor/generator for driving the accessory drive, a rechargeable electrical energy source connected to the motor/generator for driving the motor/generator on demand, the rechargeable electrical energy course connected to a vehicle electrical load, and the rechargeable electrical energy source connectable to a recharging energy source.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a schematic of the inventive system.

FIG. 2 is a chart showing the accessory torque requirement.

FIG. 3 is a chart showing the accessory power requirement.

FIG. 4 is a chart showing a comparison of power required for a prior art system and the inventive system.

FIG. 5 is a schematic of a typical prior art system.

FIG. 6 is a schematic of the inventive system.

FIG. 7 is a comparison of savings expected for a range of accessory usage.

FIG. 8 is a chart showing power output from a regenerative braking system.

FIG. 9 is a chart showing recoverable energy at the regenerative braking limit.

FIG. 10 is a chart showing system battery energy requirements based upon the amount of regenerative braking energy utilized.

### DETAILED DESCRIPTION OF THE PREFERRED EMBODIMENT

In the traditional vehicle accessory drive architecture the average power consumption is much higher for several reasons. First, the average speed of the accessories is much higher since the accessories are directly coupled to the engine crankshaft. This means they are driven in a 1:1 relationship with the crankshaft, subject to intervening pulley ratios. Second, the alternator is continuously charging the battery and so it requires approximately 1.0-1.5 kW of mechanical energy.

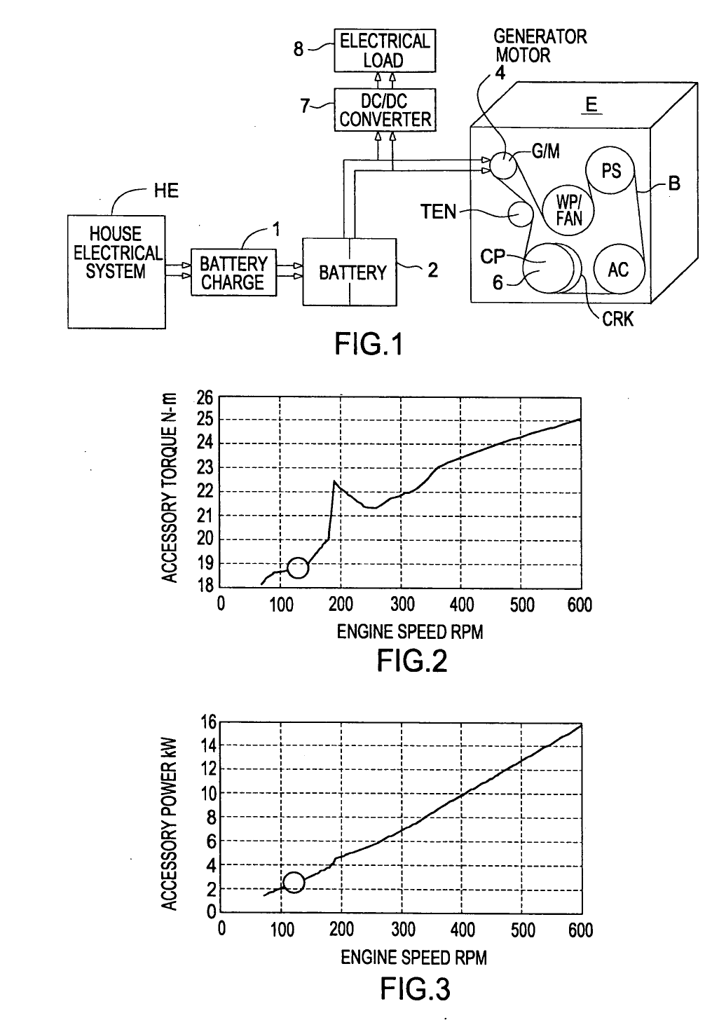

FIG. 1 is a schematic of the inventive system. The system comprises a battery charger 1 connected to a battery pack 2. Battery pack 2 is recharged by connection to an outside electrical source through battery charger 1. Battery charger 1 is contained with the vehicle in order to facilitate recharge of the battery pack from any available power source, to accommodate changes in vehicle location. The outside electrical source would in most cases be a house system (HE), or any other common power source which is connected to the local utility electrical power grid. The electrical utility grid power would normally provide power at 120V at 60 Hz, although the inventive system could be adapted to accommodate any power source parameters. The charger may comprise any suitable known in the art, for example, an 80 amp, 12 V commercial charger available from Automotive Parts Network. A charger of this type will recharge the battery pack in approximately 4-5 hours. This is sufficient to overnight charging when electric demand and therefore electric rates are reduced.

The batteries comprise any known in the art, including deep discharge lead acid. For example, Energy Alternatives Ltd (EA) model L16 Deep Cycle 6 volt, 360 Ah described at http://www.energyalternatives.ca/catalogue/Items/L16.htm. Two EA units will have a capacity of approximately 4.3 kW-hr. The EA battery is deep cycle and rated at 6 volt, 360 Amp hours. Another is a Delphi part no. D20-60V deep cycle sealed wet lead acid battery, described at http://www.solardome.co.za/Pdf/Delphi%20Deep%20Cycle%20Batt eries.pdf. Two Delphi battery units will have capacity of approximately 4.08 kW-hr.

Engine (E) is an internal combustion engine used on a variety of vehicles. Belt driven accessories on the engine may comprise, but are not limited to, a water pump (WP), a power steering pump (PS), and an air conditioning compressor (AC). The accessories are drivingly connected to the crankshaft (CRK) by a belt (B) in a manner known in the art. A tensioner (TEN) provides a belt preload in a manner known in the art as well.

On the engine (E) a motor/generator 4 is used in place of a traditional alternator. The motor/generator is readily available, for example, an Electric Vehicles USA, Inc. motor, namely, a Scott 4BD2267 12-24 VDC 4 HP, ⅝″ Shaft, 4 hp continuous output at 150 Amps and 24 volts. The efficiency is approximately 80% at 3600 RPM. Torque output is approximately 8 inch-ounces per amp. The motor is more fully described at http://www.electricvehiclesusa.com/product p/mo-4bd2267.htm. Another suitable motor/generator is the Lynch Motor Company LMC 170 which is an axial gap D.C. brush motor. The LMC motor/generator weighs approximately 8.5 kg., and is a 48V motor with an output of up to approximately 7 kW. The motor is more fully described at http://www.lemcoltd.com/lem 170.htm.

A clutch 6 connects crankshaft pulley CP to the crankshaft CRK. Clutch 6 may comprise an electromagnetic clutch, hydraulic clutch or a dry-friction clutch depending upon system requirements. In the preferred embodiment clutch 6 is electromagnetic. For example, clutch 6 may comprise an OGURA INDUSTRIAL CORPORATION electromagnetic clutch part no. 515376, or other suitable, equivalent clutch.

During operation of the system, battery pack 2 is discharged as it provides power to motor 4. Motor 4 drives all the belt driven accessories (AC, PS, WP) of the engine at a constant optimum speed. The optimum speed is approximately 1000 rpm, but this is adjustable in order to optimize accessory operation. When the accessories are driven by motor 4, clutch 6 is disengaged, thereby isolating the belt driven accessory drive from the engine crankshaft. FIG. 2 is a chart showing the accessory torque requirement. The total accessory torque is approximately 19 N-m.

Battery power also serves the vehicle electrical loads 8. Battery power is conditioned at necessary through a DC/DC converter 7, for example, stepped up from 12V to 42V depending upon the electrical load 8 requirements. Battery power may also be provided to the system at 12V as well. Various vehicle electrical loads 8 may include cabin and exterior lights, heating, navigation, ventilation fans, adjustable seats, heated seats, and so on. As noted elsewhere, the air conditioner compressor AC, power steering pump PS and water pump WP are driven by the motor 4 through belt B when clutch 6 is disengaged and battery power is provided to motor 4.

The belt driven accessories are driven by motor 4 at a constant low speed regardless of the operational speed of the engine. The accessories are mechanically decoupled from the engine by clutch 6. When driven at a constant and relatively low speed the accessories consume substantially lower levels of energy. For example, in the example system the average power required to propel the accessories is approximately 2 kW at 1000 RPM. FIG. 3 is a chart showing the accessory power requirement. When the air conditioning compressor is ON, the accessory total power requirement will be higher and can reach approximately 3 kw. When air conditioning compressor is OFF the total power requirement will be approximately around 1 kw. By comparison, the engine speed can vary from approximately 800 RPM up to 8000 RPM or more.

The batteries 2 are sized to provide approximately four hours of accessory operation, which roughly equates to 100 miles of driving. This power capability will accommodate most in city driving situations.

When batteries 2 are fully discharged clutch 6 can be engaged and the accessories (AC, WP, PS) and generator 6 will then be driven by the internal combustion engine E in the traditional manner using belt B. The generator output will then satisfy the electrical loads 8 while the engine also drives the belt driven accessories AC, WP and PS.

Most deep cycle batteries allow approximately 50% discharge. At approximately 40% charge remaining the electromagnetic clutch 6 is engaged. In some cases the batteries may discharge down to 20%. The voltage drop is down to approximately 11.5V to 11.8V at which point the electromagnetic clutch 6 is engaged to provide energy for the electrical loads 8. However, the generator only provides electrical energy sufficient to power the operational electrical loads without recharging the batteries. For example, once the batteries are discharged to a charge state of approximately 20-40%, clutch 6 engages, however, the control system monitors the battery charge state to maintain that charge level without recharging the batteries. In this case substantially all of the electrical energy generated by generator 4 is used to satisfy the electrical loads. The generator output can be adjusted by the control system in order to follow electric load system demand. Of course, if required the control system can increase generator output sufficient to recharge the batteries, but this is only on an “as needed” basis, and, will result in decreased fuel savings if used. In the alternative the batteries may be electrically disconnected from the system to fully isolate them until they are recharged by the outside source. In the preferred embodiment, in order to realize the described savings the batteries are only recharged by the electric grid and not by the IC engine.

In an alternate operating mode the batteries need not be recharged from the utility electrical grid. Instead, they are recharged during highway driving by the motor/generator 4 in generate mode. They are then used (discharged) in city driving to power the accessories using the belt and to provide for the vehicle electric loads. Recharge during driving requires clutch 6 to be engaged, thereby transmitting torque from the crankshaft through belt B to each accessory, including the generator 4. This mode may be selected when a recharge power source is not readily available.

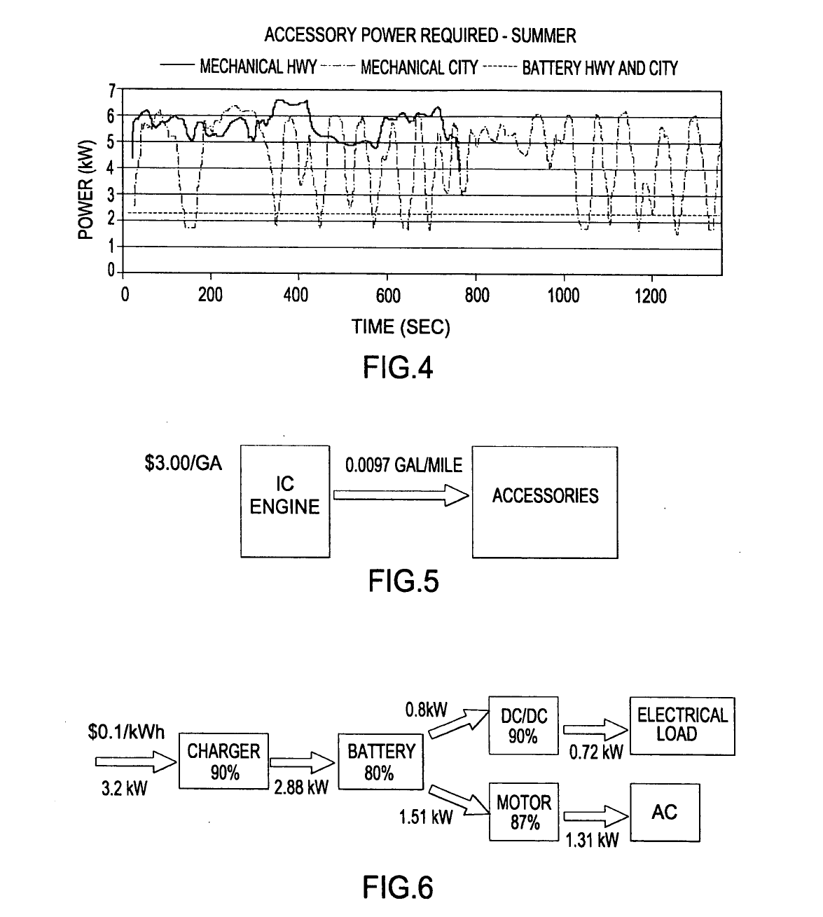

FIG. 4 is a chart showing a comparison of power required for a prior art system and the inventive system. In a typical drive cycle, the mechanical power requirement for the accessories is approximately 5.5 kW for a highway drive cycle. The typical mechanical power requirement for a city drive cycle is approximately 4.5 kW. By comparison, the typical drive cycle requirement using the inventive system is approximately 2.3 kW. This represents a significant reduction of approximately 58% in accessory load over the highway cycle and a significant reduction of approximately 48% over the city drive cycle.

FIG. 5 is a schematic of a typical prior art system. Based on an assumed fuel cost of $3.00/gallon, it is estimated that an average IC engine will consume approximately 0.0097 gal/mile for a typical drive cycle to drive the accessories. Over a distance of 100 miles this is approximately $2.91 in fuel to power the accessories.

FIG. 6 is a schematic of the inventive system. The typical efficiency for the charger, battery, DC/DC converter, and motor are noted in the figure for each component. The accessory load is broken into two parts, namely, the electrical load (other than accessories on the engine) and the accessory load, namely, the air conditioner compressor (AC), water pump (WP), power steering pump (PS). Estimated electrical power requirements for each segment are as noted in the figure.

Based on an assumed electrical cost of ˜$0.1 kWhr, it is estimated that a vehicle and IC engine will consume approximately 6.4 kW of electrical energy to operate the accessories over a typical 100 mile route. This equates to approximately $1.06 in electrical cost to operate the accessories over the 100 mile driven distance.

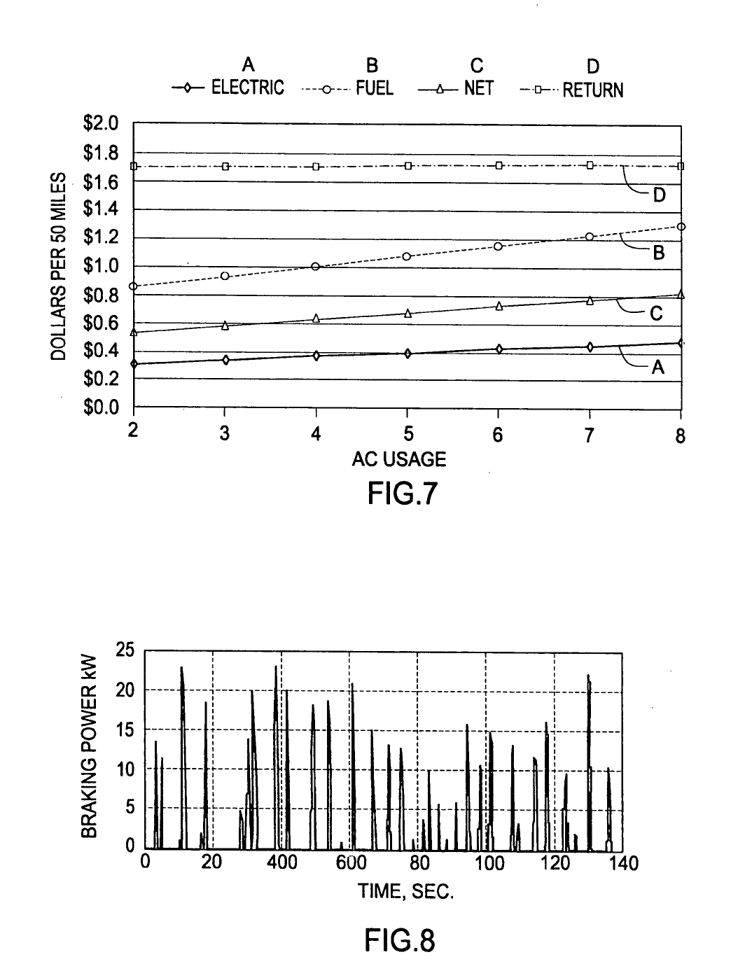

FIG. 7 is a comparison of savings expected for a range of accessory usage. Line A represents the electrical usage to power the accessories for a drive distance of 50 miles. Line B represents the fuel usage for the accessories for the same distance. Line C represents the net between the electrical use and the fuel use. Line D represents the expected financial savings for the drive distance.

Using the assumption noted for FIGS. 5 and 6 of a drive cycle of 100 miles, the net savings is approximately:

$2.91−$1.06=$1.85

by using the inventive system to power the vehicle accessories. This includes the added benefit of greater power being made available to the driving wheels of the vehicle (by removing the accessory and electrical load) for no change in engine size.

Based on simulations and test results it is expected that the system will save approximately 10-30% of fuel depending on the type and size of the vehicle. It is expected that electricity will cost about 30% of the cost of the saved fuel. In other words for an average consumer with yearly fuel spending of approximately $2500, $500 in fuel cost will be saved, assuming a conservative 20% reduction of fuel usage. Electricity will cost approximately $150 a year, therefore, the net total realized savings will be approximately $350 a year.

An additional benefit of the inventive system is a reduction of engine CO and NO emissions in populated areas. This is the direct result of the reduction on fuel consumed per mile driven. The reduction in emissions is directly proportional to the reduction in fuel consumption.

A further benefit of the invention is emissions reduction by a substantial engine downsizing, again made possible by the reduced or eliminated accessory load. In order to provide occasional peak horsepower an electrically driven supercharger can be utilized on the otherwise downsized engine. A 4 to 5 kW supercharger can increase engine output by approximately 20-30 kW. The supercharger can be operated by electric motor during those times when a temporary increase in engine output is required. When the additional output is not required the supercharger motor is deactivated.

Another advantage of the invention is to provide charging options for proposed vehicle. The power requirement of the system is relatively low, consequently, the charging time for the battery pack is relatively short. For example, to improve recharging convenience parking meters can be combined with electrical chargers or electrical outlets to provide short interval recharge.

Further, potential application of the proposed invention is not limited to a particular type of vehicle. The system can be used on passenger vehicles, pick-up trucks, SUV's, minivans, delivery vehicles, city buses, and other vehicles.

Another alternative for the system is to use regenerative braking. FIG. 8 is a chart showing power output from a regenerative braking system. For a typical vehicle weighing ˜3000 pounds the total available braking power is approximately 23 kW. The regenerative system can be used to drive the accessories or to recharge the batteries during braking. Use of a regenerative braking system reduces the required battery capacity by approximately 25%. This advantage is based upon recovery of approximately 7.5 kW from the regenerative braking system. The regenerative braking is provided by clutch 6 being engaged and motor/generator 4 operated in generate mode, thereby briefly recharging the batteries. During regenerative braking the use of generator 4 and engagement of clutch 6 occurs regardless of the state of charge of the batteries. If necessary, the control system can control the stator field strength on the generator in order to avoid overcharging the batteries. Control systems capable of providing this functionality are known in the art.

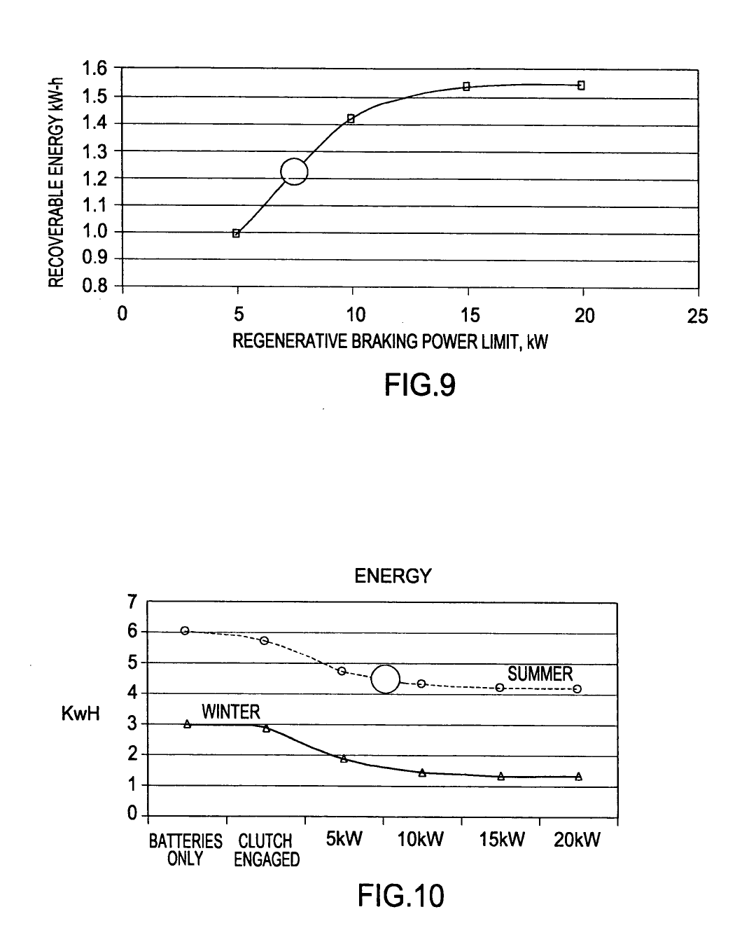

FIG. 9 is a chart showing recoverable energy at the regenerative braking limit. For the proposed 7.5 kW system the recoverable energy is approximately 1.2 kW-hr.

FIG. 10 is a chart showing system battery energy requirements based upon the amount of regenerative braking energy utilized. For a system recovery of 7.5 kW, and assuming summer driving, the system can recover a total of approximately 4.5 kW-hr. This represents a significant contribution to the total energy use which allows a reduction in the frequency and duration of recharging time that would otherwise be required.

Although forms of the invention have been described herein, it will be obvious to those skilled in the art that variations may be made in the construction and relation of parts without departing from the spirit and scope of the invention described herein.

1. A plug-in hybrid accessory belt drive system comprising:
an internal combustion engine accessory belt drive, the accessory belt drive drivable by the internal combustion engine and further comprising engine accessories;
a motor/generator drivingly engaged with the accessory belt drive, the accessory belt drive drivable by the motor/generator;
a rechargeable electrical energy source connected to the motor/generator for powering the motor/generator on demand and which rechargeable electrical energy source is also rechargeable by the motor/generator;
the rechargeable electrical energy source connected to a vehicle electrical load; and
the rechargeable electrical energy source connectable to a recharging energy source.

2. The plug-in hybrid accessory belt drive system as in claim 1, wherein the rechargeable electrical energy source comprises a battery..

3. The plug-in hybrid accessory belt drive system as in claim 1 further comprising:
a clutch mechanically disposed in the accessory belt drive such that when the clutch is engaged the engine drives the accessory belt drive system; and
the clutch is not engaged when the motor/generator is driving the accessory belt drive system.

4. The plug-in hybrid accessory belt drive system as in claim 3, wherein when the clutch is engaged the generator does not provide power to recharge the rechargeable energy source.
